(19) United States
(12) Patent Application Publication
(10) Pub. No.: US 2024/0079689 A1
(43) Pub. Date: Mar. 7, 2024

(54) LAMINATE TYPE SOLID-STATE BATTERY

(71) Applicant: HONDA MOTOR CO., LTD., Tokyo (JP)

(72) Inventors: Takuya TANIUCHI, Saitama (JP); Tadashi MATSUSHITA, Saitama (JP); Toshiyuki ARIGA, Saitama (JP)

(21) Appl. No.: 18/357,176

(22) Filed: Jul. 24, 2023

(30) Foreign Application Priority Data
Sep. 2, 2022 (JP) 2022-140198

(51) Int. Cl. H01M 50/124; H01M 50/107; H01M 50/126; H01M 50/131

(52) U.S. Cl. CPC H01M 50/1243; H01M 50/107; H01M 50/126; H01M 50/131

(57) ABSTRACT

To provide a laminate type solid-state battery capable of preferably accommodating an electrode laminate. A laminate type solid-state battery comprising: an electrode laminate; and a casing body being formed of a laminate film and accommodating the electrode laminate, the casing body comprising an insulating member in an interior thereof, the insulating member abutting at least one of laminate end surfaces of the electrode laminate, the insulating member having an inclined surface that outwardly inclines from the electrode laminate in a cross-sectional view along the laminate direction, the inclined surface and the laminate surface of the electrode laminate forming an angle greater than 90° and less than 180°.

This application is based on and claims the benefit of priority from Japanese Patent Application No. 2022-140198, filed on 2 Sep. 2022, the content of which is incorporated herein by reference.

### BACKGROUND OF THE INVENTION

### Field of the Invention

The present invention relates to a laminate type solid-state battery.

### Related Art

In recent years, research and development have been conducted on secondary batteries that contribute to energy efficiency, in order to ensure more people have access to reliable, sustainable, and advanced energy at an affordable price. As a secondary battery, a solid battery using a solid electrolyte as an electrolyte has attracted attention.

The solid-state battery has an electrode laminate in which a positive electrode, a solid electrolyte, and a negative electrode are laminated. A technology for covering laminate end surfaces of the electrode laminate with an insulating resin in order to prevent damage and ensure insulation is disclosed (for example, see Patent Document 1).

As a casing body that accommodates the electrode laminate, there is known a laminate casing body produced by welding one or two laminate films.
Patent Document 1: Japanese Unexamined Patent Application, Publication No. 2020-004697

### SUMMARY OF THE INVENTION

Conventional technology, including the technology disclosed in Patent Document 1, includes insulating members 31g and 32g each having a square shape in a cross-sectional view arranged at end portions of the electrode laminate, as shown in FIG. 9. Therefore, when an electrode laminate 2 and the insulating members 31g and 32g are placed in casing bodies 41g and 42g, there is a possibility that wrinkles or cracks may occur in corner portions c6. In addition, welding of welding portions j1 and j2 may become insufficient during manufacturing, and sealing performance may be impaired by expansion of the electrode laminate due to charging and discharging of a laminate type solid-state battery 1g.

The present invention has been made in view of the above circumstances, and an object of the present invention is to provide a laminate type solid-state battery capable of preferably accommodating an electrode laminate.

(1) A first aspect of the present disclosure relates to a laminate type solid-state battery including: an electrode laminate; and a casing body being formed of a laminate film and accommodating the electrode laminate, the casing body including an insulating member disposed in an interior thereof, the insulating member abutting at least one of laminate end surfaces of the electrode laminate, the insulating member having at least one inclined surface that outwardly inclines from the electrode laminate in a cross-sectional view along a lamination direction, the inclined surface and a laminate surface of the electrode laminate forming an angle greater than 90° and less than 180°.

According to the first aspect, it is possible to provide a laminate type solid-state battery capable of preferably accommodating the electrode laminate.

(2) A second aspect of the present disclosure relates to the laminate type solid-state battery as described in the first aspect, in which the at least one inclined surface includes a plurality of inclined surfaces.

According to the second aspect, it is possible to provide a laminate type solid-state battery capable of more preferably accommodating the electrode laminate.

(3) A third aspect of the present disclosure relates to the laminate type solid-state battery as described in the first or second aspect, in which the inclined surface has a curved surface.

According to the third aspect, it is possible to provide a laminate type solid-state battery capable of more preferably accommodating the electrode laminate.

(4) A fourth aspect of the laminate type solid-state battery as described in the first or second aspect, in which the casing body has a welding portion, and in the interior of the casing body, a H₂S absorbent material and/or H₂O absorbent material is disposed between the insulating member and the welding portion.

According to the fourth aspect, it is possible to prevent water from intruding into the interior of the casing body to generate hydrogen sulfide, whereby the casing body is prevented from expanding and damaging the welding portion of the casing body.

(5) A fifth aspect of the present disclosure relates to the laminate type solid-state battery as described in the first or second aspect, in which the casing body is formed of a sheet of laminate film, and the insulating member abutting one of laminate end surfaces of the electrode laminate has a planar portion along the laminating direction of the electrode laminate, the one of laminate end surfaces of the electrode laminate being in a side in which the welding portion of the casing body is not formed.

According to the fifth aspect of the present disclosure, a plurality of laminate type solid-state batteries can be easily modularized.

### BRIEF DESCRIPTION OF THE DRAWINGS

FIG. 1 is a cross-sectional view showing a configuration of the laminate type solid-state battery according to a first embodiment;

FIG. 2 is a top view showing the configuration of the laminate type solid-state battery according to the first embodiment;

FIG. 3 is an enlarged schematic cross-sectional view of the main part of FIG. 1;

FIG. 4 is a cross-sectional view showing a configuration of the laminate type solid-state battery according to a second embodiment;

FIG. 5 is a cross-sectional view showing a configuration of the laminate type solid-state battery according to a third embodiment;

FIG. 6 is a cross-sectional view showing a configuration of the laminate type solid-state battery according to a fourth embodiment;

FIG. 7 is a cross-sectional view showing a configuration of the laminate type solid-state battery according to a fifth embodiment;

FIG. 8 is a cross-sectional view showing a configuration of the laminate type solid-state battery according to a sixth embodiment;

FIG. 9 is a cross-sectional view showing a structure of the laminate type solid-state battery according to conventional art; and

FIG. 10 is a cross-sectional view showing a configuration of a battery module formed by the laminate type solid-state battery according to a seventh embodiment.

### DETAILED DESCRIPTION OF THE INVENTION

### First Embodiment

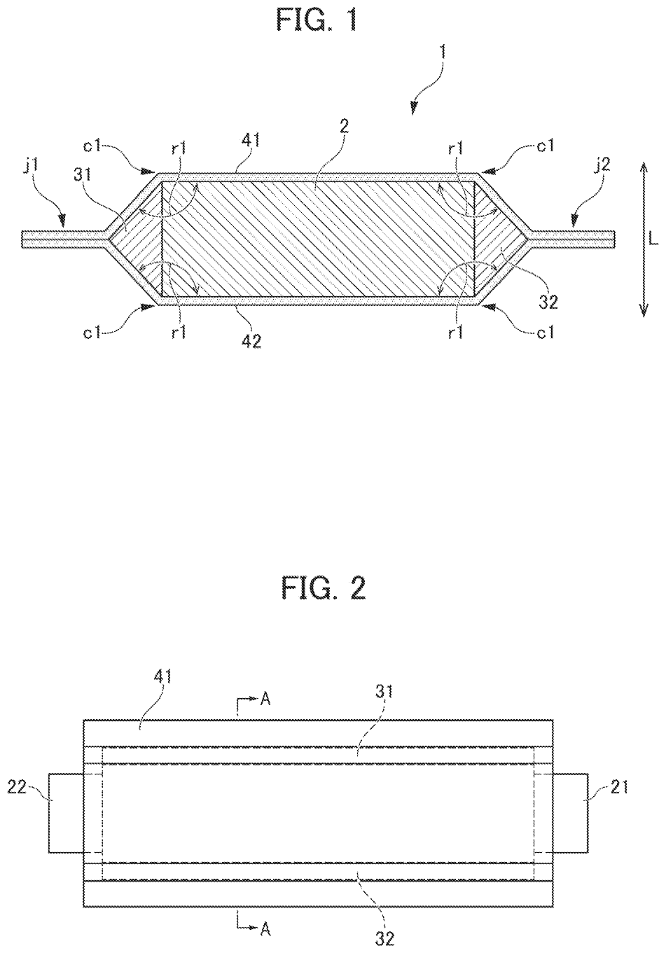

As shown in FIG. 1, a laminate type solid-state battery 1 according to the present embodiment is configured such that an electrode laminate 2 including a solid electrolyte as the electrolyte is accommodated in casing bodies 41 and 42 formed of laminate film. Insulating members 31 and 32 are disposed in the interior of the casing bodies 41 and 42 in order for the insulating members 31 and 32 to abut laminate end surfaces of the electrode laminate 2.

[Electrode Laminate]

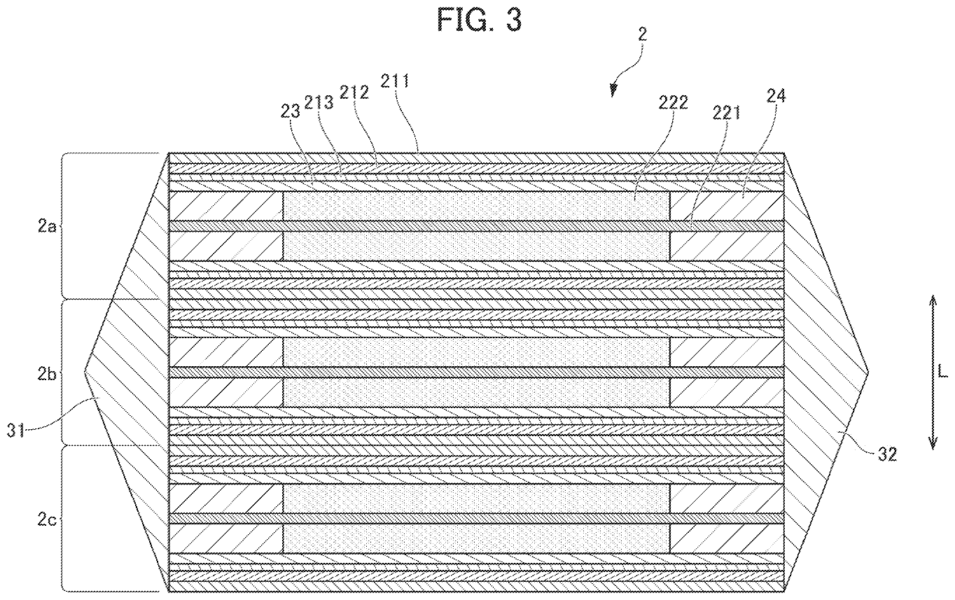

FIG. 3 is a schematic drawing showing a configuration of the electrode laminate 2 according to the present embodiment. As shown in FIG. 3, the electrode laminate 2 has a laminate structure in which a negative electrode layer including a negative electrode current collector 211 and a negative electrode active material layer 212, an intermediate layer 213, a solid electrolyte layer 23, and a positive electrode layer including a positive electrode active material layer 222 and a positive electrode current collector 221 are laminated in this order. The laminate end surfaces of the positive electrode active material layer 222 are covered with an insulating layer 24. A laminate unit 2a is formed by laminating the laminate structure in order for the same electrodes (negative electrode layers in FIG. 3) to abut each other. More specifically, the laminate unit 2a is formed by laminating a double-side-coated positive electrode layer including positive electrode active material layers 222 on both sides of a single positive current collector 221, such that the double-side-coated positive electrode layer is interposed by two negative electrode layers, via the intermediate layer 213 and the solid electrolyte layer 23. In FIG. 3, three laminate units 2a, 2b, and 2c are shown, but the number of laminate units is not particularly limited.

(Negative Electrode Layer)

The negative electrode current collector 211 is not particularly limited as long as it has function of collecting electric current of the negative electrode layer, and examples of materials of the negative electrode current collector include nickel, copper, and stainless steel. Examples of the shape of the negative electrode current collector include a foil shape, a plate shape, etc. The negative electrode current collector 211 is electrically connected to a negative electrode terminal 21 in FIG. 2.

A negative electrode active material layer 212 is a layer containing a negative electrode active material as an essential component. The negative electrode active material is not particularly limited as long as it can occlude and release a charge transfer medium and examples thereof include lithium transition metal oxides such as lithium titanate (Li₄Ti₅O₁₂), transition metal oxides such as TiO₂, Nb₂O₃ and WO₃, metal sulfides, metal nitrides, carbon materials such as graphite, soft carbon and hard carbon, metallic lithium, metallic indium, and lithium alloys. The negative electrode active material may be in the form of a powder or a thin film. The negative electrode active material layer 212 may contain a conductive aid for improving conductivity and a binder in addition to the negative electrode active material. As the conductive aid and the binder, materials generally used in solid-state batteries can be used.

(Intermediate Layer)

The intermediate layer 213 is a layer laminated between the negative electrode active material layer 212 and the solid electrolyte layer 23. By providing the intermediate layer 213, non-uniform metal deposition between the negative electrode active material layer 212 and the solid electrolyte layer 23 can be suppressed. The intermediate layer 213 is not particularly limited as long as it is a layer having electron conductivity and ion conductivity, and materials generally used for solid-state batteries can be used.

(Solid Electrolyte Layer)

The solid electrolyte layer 23 is a layer containing at least a solid electrolyte material. The charge transfer medium conduction between the positive electrode active material and the negative electrode active material can be performed through the solid electrolyte material included in the solid electrolyte layer.

The solid electrolyte material is not particularly limited as long as it has charge transfer medium conductivity, i.e., ion conductivity, and examples thereof include a sulfide solid electrolyte material, an oxide solid electrolyte material, a nitride solid electrolyte material, and a halide solid electrolyte material.

Examples of the sulfide solid electrolyte material include Li₂S—P₂S₅, Li₂S—P₂S₅—LiI, etc. in the case of lithium ion batteries. The recitation “Li₂S—P₂S₅” means a sulfide solid electrolyte material using a raw material composition containing Li₂S and P₂S₅.

As examples of the oxide solid electrolyte material, an NASICON type oxide, a garnet type oxide, and a perovskite type oxide can be mentioned in the case of lithium ion batteries.

As examples of the NASICON type oxide, oxides containing Li, Al, Ti, P and O (for example, Li_{1.5}Al_{0.5}Ti_{1.5}(PO₄)₃) can be mentioned. As examples of the garnet type oxide, oxides containing Li, La, Zr and O (for example, Li₇La₃Zr₂O₁₂) can be mentioned. As examples of the perovskite type oxide, oxides containing Li, La, Ti and O (for example, LiLaTiO₃) may be mentioned.

(Positive Electrode Layer)

The positive electrode current collector 221 is not particularly limited as long as it has function of collecting current of the positive electrode layer, and examples thereof include aluminum, aluminum alloy, stainless steel, nickel, iron, and titanium, among which aluminum, aluminum alloy, and stainless steel are preferable. Examples of the shape of the positive electrode current collector include a foil shape and a plate shape. The positive electrode current collector 221 is electrically connected to a positive electrode terminal 22 in FIG. 2.

A positive electrode active material layer 222 is a layer containing at least a positive electrode active material. The positive electrode active material contained in the positive electrode active material layer 222 can be the same as that used for a positive electrode layer of a general solid-state battery and is not particularly limited. In the case of lithium ion batteries, examples include a layered active material containing lithium, a spinel type active material, and an olivine type active material. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), a hetero atom-substituted Li—Mn spinel represented by Li₁₊ₓMn_{2-x-y}M_{y}O₄ (x+y=2, M=at least one selected from Al, Mg, Co, Fe, Ni, or Zn), lithium titanate (an oxide containing Li and Ti), and metallic lithium phosphate (LiMPO₄, M=at least one selected from Fe, Mn, Co, or Ni).

The positive electrode active material layer 222 may optionally contain a solid electrolyte from the viewpoint of improving charge transfer medium conductivity. Further, a binder, a conductive aid, and the like may be contained. As these matters, those generally used in solid-state batteries can be used.

[Casing Body]

The casing bodies 41 and 42 are formed of laminate film, and accommodate the electrode laminate 2. The laminate film has a multilayer structure in which a thermally fusible resin layer made of polyolefin or the like is laminated on the surface of a metal layer made of aluminum, stainless steel (SUS), or the like. In addition to the above, a laminate cell may have a layer made of a polyamide such as nylon, a polyester such as polyethylene terephthalate, or the like, an adhesive layer made of any laminate adhesive, or the like.

In the present embodiment, the casing body includes two casing bodies 41 and 42, which are laminate film, the electrode laminate 2 is disposed between the two casing bodies 41 and 42, and the electrode laminate 2 and the insulating members 31 and 32 are sealed by welding portions j1 and j2 formed by welding the casing bodies 41 and 42.

[Insulating Members]

As shown in FIGS. 1 and 2, the insulating members 31 and 32 are disposed in the interior of the casing bodies 41 and 42, abutting the laminate end surfaces of the electrode laminate 2. By covering the laminate end surfaces of the electrode laminate 2 with the insulating members 31 and 32, the electrode laminate 2 can be prevented from being broken, and insulating property of the laminate end surfaces of the electrode laminate 2 can be ensured. Further, the insulating members 31 and 32 according to the present embodiment suppress wrinkles and cracks from occurring in the casing bodies 41 and 42. Further, the welding portions j1 and j2 can be welded more reliably.

Material of the insulating members 31 and 32 is not particularly limited as long as it has insulating property, but from the viewpoint of ease of processing and disposition, it is preferable to use an insulating resin as the material. Examples of the insulating resin include fluorine-based rubber, silicon-based rubber, styrene-butadiene rubber, and an acrylic resin.

The insulating members 31 and 32 are arranged to abut at least one of the laminate end surfaces of the electrode laminate 2. FIG. 1 is a cross-sectional view taken along line A-A of FIG. 2. In the present embodiment, the insulating members 31 and 32 are arranged such that, among four laminate end surfaces of the substantially rectangular electrode laminate 2 at the viewpoint of FIG. 2 (the viewpoint from the laminate direction), the insulating members 31 and 32 each abut surfaces other than the laminate end surfaces from which the negative electrode terminal 21 and the positive electrode terminal 22 extend. Although the laminate end surfaces of the electrode laminate 2 to be covered with the insulating member is not limited to those described above, it is preferable that at least the above-described two surfaces are covered with the insulating member, because the two surfaces other than the laminate end surfaces from which the negative electrode terminal 21 and the positive electrode terminal 22 extend are surfaces that mainly require strength of welding and need to ensure insulating property and because arrangement of the insulating members is easy. In addition to the above-described configuration, a configuration in which all of the laminate end surfaces of the electrode laminate 2 are covered with the insulating member and the insulating member is integrally formed is possible.

In addition to the surfaces abutting the laminate end surfaces of the electrode laminate 2, the insulating members 31 and 32 each have an inclined surface, in a cross-sectional view along the laminate direction L, that inclines from the electrode laminate 2 toward the welding portion j1 or j2, which is in the outside. The inclined surfaces incline from one end side and the other end side of surfaces that abut the laminate end surfaces of the electrode laminate 2 in FIG. 1, toward the welding portion j1 or j2, respectively. Since the insulating members 31 and 32 have inclined surfaces as described above, the laminate type solid-state battery 1 can be formed without forming a corner portion of 90° or less in a cross-sectional view along the laminate direction L on the laminate end surface. That is, an angle r1 between the inclined surface and the laminate surface of the electrode laminate 2 is greater than 90° and less than 180°.

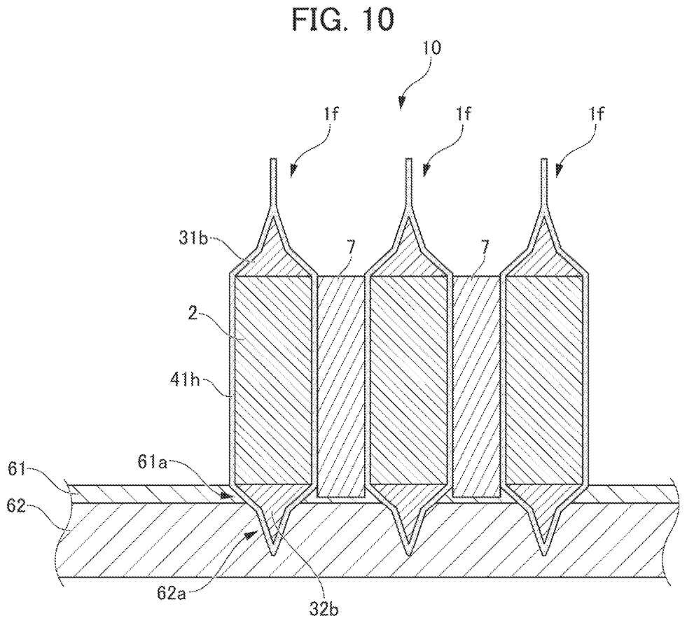

Here, a structure of a laminate type solid-state battery 1g according to the prior art will be described with reference to FIG. 9. As shown in FIG. 9, the laminate end surfaces of the electrode laminate 2 of the laminate type solid-state battery 1g abut and are covered with the insulating members 31g and 32g. Unlike the insulating members 31 and 32 according to the present embodiment, the insulating members 31g and 32g do not have inclined surfaces that incline toward the welding portion j1 or j2, and an angle r6 of about 90° in a cross-sectional view along the laminate direction L is formed on the laminate end surfaces. That is, the insulating members 31g and 32g have a substantially quadrangular prism shape as a three-dimensional shape, and a corner portion c6 is formed in each of the insulating members 31g and 32g. Since stress is concentrated on the corner c6 during sealing of the laminate film, wrinkles and cracks may occur in the corner c6 in the casing body 41g or 42g or between the corner c6 and the welding portion j1.

By the insulating members 31 and 32 according to the present embodiment, it is possible to reduce the stress applied to the corner portions formed on the laminate end surfaces during sealing of the laminate film. Therefore, occurrence of wrinkles and cracks in the casing bodies 41 and 42 during manufacturing of the laminate type solid-state battery 1 is suppressed. Further, since the stress applied to the welding portion j1 or j2 during sealing can also be reduced, the welding failure of the welding portion j1 or j2 can be reduced.

In FIG. 1, all angles formed by the inclined surface and the laminate surface of the electrode laminate 2 are shown as r1, but it is sufficient for r1 to be greater than 90° and less than 180°, and a plurality of r1 may be different angles.

In the present embodiment, the insulating members 31 and 32 have a triangular shape composed of a side that abuts the electrode laminate 2 in a cross-sectional view along the laminate direction L, and two side other than the above. Accordingly, the insulating members 31 and 32 each have a substantially triangular prism shape as a three-dimensional shape, and corner portions c1 are formed at both ends of the surfaces on which each of the insulating members 31 and 32 abuts the electrode laminate 2.

[Method of Manufacturing Laminate Type Solid-State Battery]

The method of manufacturing the laminate type solid-state battery 1 according to the present embodiment includes: forming the electrode laminate 2; forming the insulating members 31 and 32; and arranging the electrode laminate 2 and the insulating members 31 and 32 between the casing bodies 41 and 42 and welding the casing bodies at the welding portions j1 and j2 to seal the electrode laminate 2 and the insulating members 31 and 32 in the interior of the casing bodies 41 and 42.

A method of manufacturing the electrode laminate 2 may include: forming a laminate unit (lamination units 2a, 2b, and 2c in FIG. 3) shown in FIG. 3, in which a double-side-coated positive electrode layer including positive electrode active material layers 222 formed on both sides of a single positive current collector 221 is laminated via an intermediate layer 213 and a solid electrolyte layer 23 such that the double-side-coated positive electrode layer is interposed by two negative electrode layers to form a set of laminate structure including the negative electrode layer, the intermediate layer 213, the solid electrolyte layer 23, and the positive electrode layer laminated in this order; cutting the laminate unit into a predetermined size; and laminating a plurality of laminate units having the predetermined size. Thereby, it is possible to suppress lamination misalignment, as compared with a case in which each layer constituting the electrode laminate 2 is formed and then laminated. Therefore, the lamination misalignment can be easily suppressed in a region where the insulating members 31 and 32 are disposed.

The forming of the insulating members 31 and 32 may include, for example, arranging the electrode laminate 2 in the interior of a frame body that has a shape corresponding to shapes of the electrode laminate 2 and the insulating members 31 and 32; filling the gap with a material such as an insulating resin to constitute the insulating members 31 and 32; curing the material; and then removing the frame body.

The arranging of the electrode laminate 2 and the insulating members 31 and 32 between the casing bodies 41 and 42 and welding the casing bodies at the welding portions j1 and j2 and sealing is not particularly limited, but a known heat sealing method or the like can be used.

Next, a laminate type solid-state battery according to another embodiment of the present invention will be described. Hereinafter, the same components as those in the first embodiment are denoted by the same reference numerals, and description thereof may be omitted.

### Second Embodiment

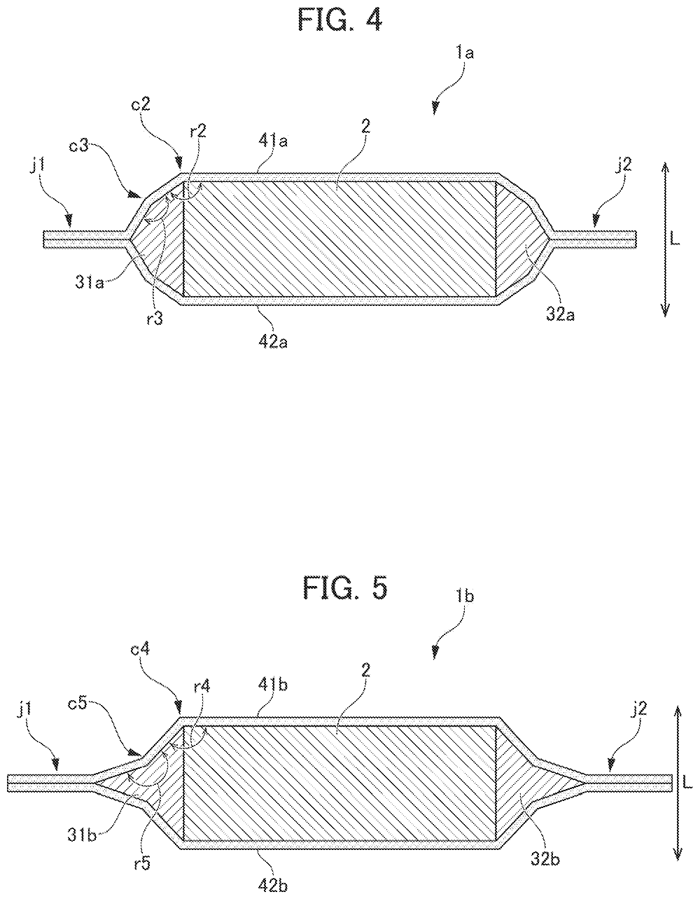

As shown in FIG. 4, a laminate type solid-state battery 1a according to the present embodiment has inclined surfaces that incline from the electrode laminate 2 toward the welding portion j1 or j2, which is in the outside. Each of the inclined surfaces includes two inclined surfaces formed between the electrode laminate 2 and the welding portion j1 or j2. An angle r2 formed by an inclined surface, the inclined surface being the one closer to the electrode laminate 2, and the laminate surface of the electrode laminate 2 is greater than 90° and less than 180°. An angle r3 formed by the two inclined surfaces is greater than 90° and less than 180°. By providing the two inclined surfaces, the angle between the inclined surface and the laminate surface of the electrode laminates 2 can be further increased without changing a distance between the electrode laminates 2 and the welding portion j1 or j2. Therefore, even by the above configuration, the same effect as that of the laminate type solid-state battery 1 according to the first embodiment can be preferably obtained. The number of inclined surfaces formed between the electrode laminate 2 and the welding portion j1 or j2 may be three or more.

Insulating members 31a and 32a according to the second embodiment have a pentagonal shape in a cross-sectional view along the lamination direction L, including a side abutting the electrode laminate 2 and four sides other than the above. Accordingly, the insulating members 31a and 32a have a substantially pentagonal prism shape as a three-dimensional shape, and corner portions c2 are formed at both ends of the surfaces on which each of the insulating members 31a and 32a abuts the electrode laminate 2. Corner portions c3 are formed between the inclined surfaces of the insulating members 31a and 32a.

### Third Embodiment

As shown in FIG. 5, a laminate type solid-state battery 1b according to the present embodiment has inclined surfaces that incline from the electrode laminate 2 toward the welding portion j1 or j2, which is in the outside. As in the laminate type solid-state battery 1a according to the second embodiment, each of the inclined surfaces formed between the electrode laminate 2 and the welding portions j1 or j2 includes two inclined surfaces. An angle r4 formed by an inclined surface of the two inclined surfaces, the inclined surface being the one closer to the electrode laminate 2, and the laminate surface of the electrode laminate 2 is greater than 90° and less than 180°. An angle r5 between the two inclined surfaces is greater than 180°. Even by the above configuration, the same effect as that of the laminate type solid-state battery 1 according to the first embodiment can be obtained.

The insulating members 31b and 32b according to the third embodiment have a substantially pentagonal shape in a cross-sectional view along the lamination direction L, including a side abutting the electrode laminate 2 and four sides other than the above. Accordingly, the insulating members 31b and 32b have a substantially pentagonal prism shape as a three-dimensional shape, and corner portions c4 are formed at both ends of the surfaces on which each of the insulating members 31b and 32b abuts the electrode laminate 2. Corner portions c5 are formed between the inclined surfaces of the insulating members 31b and 32b.

### Fourth Embodiment

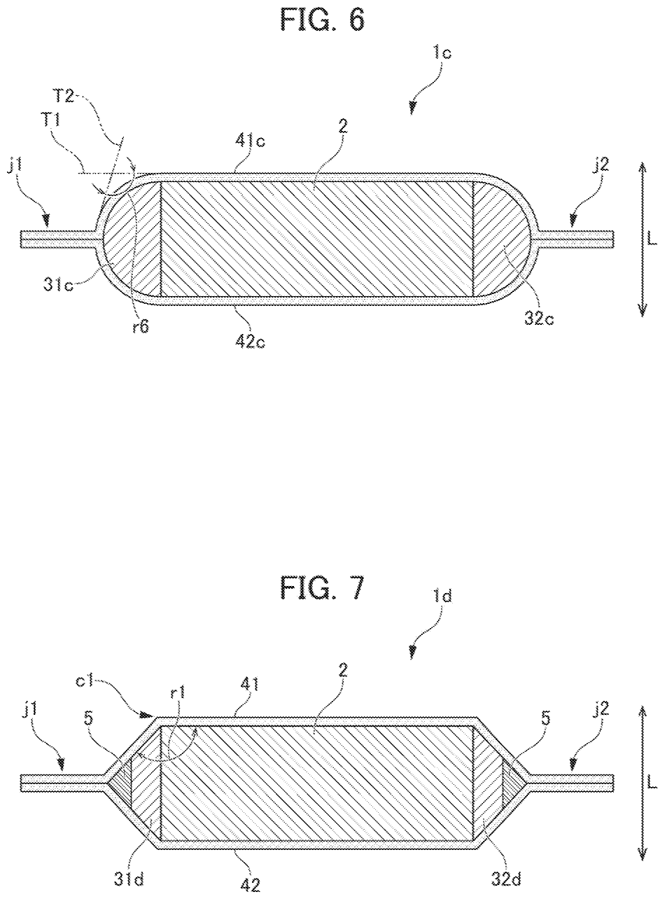

As shown in FIG. 6, a laminate type solid-state battery 1c according to the present embodiment has inclined surfaces that incline from the electrode laminate 2 toward the welding portion j1 or j2, which is in the outside. In the present embodiment, all of the inclined surfaces are formed of a curved surface. Only a part of the inclined surface may be formed as a curved surface. As shown in FIG. 6, an angle formed between the inclined surface and the laminate surface of the electrode laminate 2 is defined by an angle r6 formed between a laminate surface T1 and a tangent plane T2 at a randomly selected contact position of the curved surface as the inclined surface. Regardless of the position of the contact position on the curved surface, r6 is greater than 90° and less than 180°. Even by the above configuration, the same effect as that of the laminate type solid-state battery 1 according to the first embodiment can be obtained.

Insulating members 31c and 32c according to a fourth embodiment have a substantially semicircular shape in a cross-sectional view along the lamination direction L, including a side abutting the electrode laminate 2 and the curved surface other than the above. Accordingly, the insulating members 31c and 32c have a substantially semi-cylindrical shape as a three-dimensional shape.

### Fifth Embodiment

As shown in FIG. 7, a laminate type solid-state battery 1d according to the present embodiment has inclined surfaces that incline from the electrode laminate 2 toward the welding portion j1 or j2, which is in the outside. The inclined surface has the same configuration as the laminate type solid-state battery 1 according to the first embodiment.

The laminate type solid-state battery 1d according to the present embodiment includes insulating members 31d and 32d. In the interior of the casing bodies 41 and 42, an absorbent material 5 is disposed between the insulating member 31d or 32d and the welding portion j1 or j2, respectively. The absorbent material 5 is a H₂S absorbent and/or a H₂O absorbent. In a case a sulfide-based solid electrolyte material is used as the solid electrolyte material, if water penetrates into the inside of the casing body 41 or 42, the sulfide-based solid electrolyte material may react with water to generate hydrogen sulfide, which may cause the casing body 41 or 42 to expand, resulting in rupture. Since the absorbent material 5 can absorb water that has penetrated from the outside or hydrogen sulfide generated, the above-described situation can be prevented.

### Sixth Embodiment

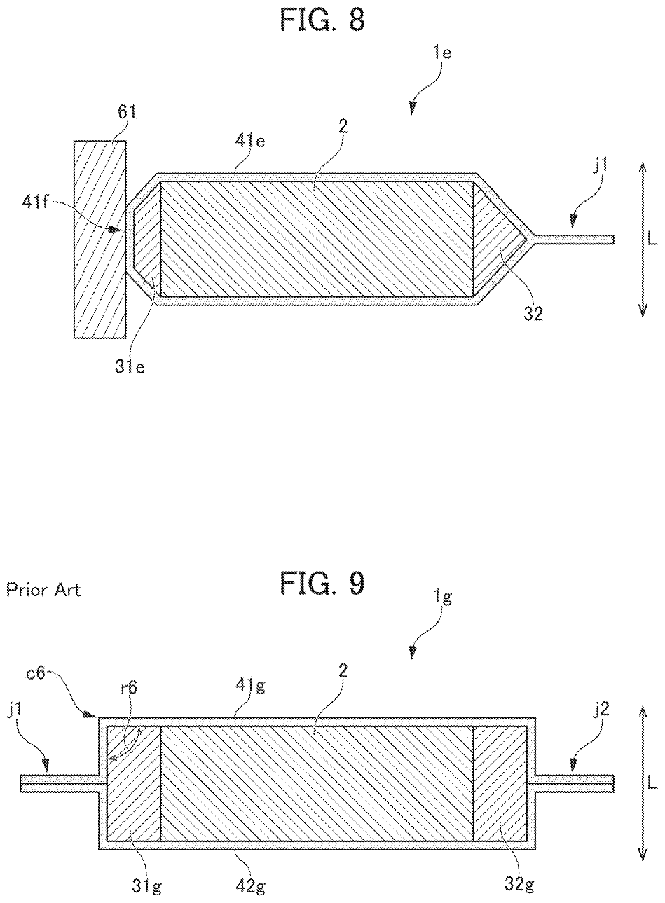

As shown in FIG. 8, a casing body of the laminate type solid-state battery 1e according to the present embodiment includes a sheet of casing body 41e. One of laminate end surfaces of the electrode laminate 2 is covered with an insulating member 32, and the casing body 41e is welded at the welding portion j1. The other of the laminate end surfaces of the electrode laminate 2 is covered with an insulating member 31e. As in the above embodiment, the laminate type solid-state battery 1e has inclined surfaces that outwardly incline from the electrode laminate 2. Even by the above configuration, the same effect as that of the laminate type solid-state battery 1 according to the first embodiment can be obtained.

In the sixth embodiment, the insulating member 31e that abuts a laminate end surface in a side in which the welding portion j1 is not formed has a side that abuts the electrode laminate 2, two inclined surfaces that outwardly incline from the electrode laminate 2, and a planar portion formed between the two inclined surfaces. The planar portion is a plane along the lamination direction L. Since the insulating member 31e has a plane along the lamination direction L, the casing body can be formed by a sheet of the casing body 41e. Further, since a plane 41f along the planar portion is also formed in the casing body 41e, the plane 41f can be disposed in contact with a module constituent member 61 as shown in FIG. 8, and thus a solid-state battery module can be easily formed using the laminate type solid-state battery 1e.

### Seventh Embodiment

[Solid Battery Module]

Next, the configuration of a solid-state battery module 10 formed by stacking a plurality of laminate type solid-state batteries if according to the present embodiment will be described with reference to FIG. 10. As shown in FIG. 10, the solid-state battery module 10 includes a plurality of laminate type solid-state batteries if arranged along the lamination direction, a separator 7 arranged between the laminate type solid-state batteries 1f, a heat transfer material 61 as the module constituent member, and a lower plate 62. The configuration of a laminate type solid-state battery if is the same as that of the laminate type solid-state battery 1b except that the casing body is formed of a sheet of casing body 41h. Incidentally, the separator 7 has insulating function to electrically and physically separate the laminate type solid-state batteries if from each other. The separator 7 may have buffer function or heat transfer function in addition to the insulating function.

In the heat transfer material 61 and the lower plate 62, holes 61a and 62a corresponding to the shape of the insulating member 32b of the laminate type solid-state battery if are formed. Since the casing body 41h is not provided with a welding portion in the side in which the insulating member 32b is to be disposed, a plurality of laminate type solid-state batteries if can be easily fixed by inserting an end surface of each laminate type solid-state battery if in the side in which the insulating member 32b is to be disposed, into holes 61a and 62a, which correspond to the shape of the insulating member 32b.

Although preferred embodiments of the present invention have been described above, the present invention is not limited to the above embodiments, and modifications and improvements within the scope of achieving the object of the present invention are included in the present invention.

### EXPLANATION OF REFERENCE NUMERALS

1, 1a, 1b, 1c, 1d, 1e and 1f: Laminate type solid-state battery
2: Electrode laminate
31, 31a, 31b, 31e, 32, 32a and 32b: Insulating member
41, 41a, 41b, 41c, 41e, 41f and 41h: Casing body
42, 42a, 42b, 42c: Casing body

What is claimed is:

1. A laminate type solid-state battery comprising: an electrode laminate; and a casing body being formed of a laminate film and accommodating the electrode laminate,
the casing body comprising an insulating member in an interior thereof, the insulating member abutting at least one of laminate end surfaces of the electrode laminate,
the insulating member having at least one inclined surface that outwardly inclines from the electrode laminate in a cross-sectional view along the laminate direction,
the inclined surface and the laminate surface of the electrode laminate forming an angle greater than 90° and less than 180°.

2. The laminate type solid-state battery according to claim 1, wherein the at least one inclined surface comprises a plurality of inclined surfaces.

3. The laminate type solid-state battery according to claim 1, wherein the inclined surface has a curved surface.

4. The laminate type solid-state battery according to claim 1,
wherein the casing body has a welding portion, and
a H₂S absorbent and/or a H₂O absorbent is disposed between the insulating member and the welding portion in the interior of the casing body.

5. The laminate type solid-state battery according to claim 1, wherein the casing body is composed of a sheet of laminate film, and
the insulating member abutting one of laminate end surfaces of the electrode laminate has a planar portion along the laminating direction of the electrode laminate, the one of laminate end surfaces of the electrode laminate being in a side in which the welding portion of the casing body is not formed.
